(19) United States
(12) Patent Application Publication
(10) Pub. No.: US 2026/0071761 A1
(43) Pub. Date: Mar. 12, 2026

(54) METHOD AND APPARATUS FOR TEMPERATURE REGULATION OF CEILING HEATER

(71) Applicant: BROMIC HEATING PTY LIMITED, New South Wales (AU)

(72) Inventor: Scott Smith, New South Wales (AU)

(21) Appl. No.: 19/107,898

(22) PCT Filed: Aug. 22, 2023
(86) PCT No.: PCT/AU2023/050797

§ 371 Date: Feb. 28, 2025

(30) Foreign Application Priority Data
Aug. 31, 2022 (AU) 2022902501

(51) Int. Cl. F24D 13/02; F24H 3/02; F24H 9/00; F24H 15/128; F24H 15/20; F24H 15/345; H05B 1/02

(52) U.S. Cl. CPC F24D 13/02; F24H 3/022; F24H 9/0073; F24H 15/128; F24H 15/20; F24H 15/345; H05B 1/0275

(57) ABSTRACT

This application is directed to a heating apparatus for mounting within a ceiling. The heating apparatus includes an enclosure, a heating element mounted to a portion on the enclosure, a temperature sensor for detecting a temperature of the enclosure, and a fan located within the enclosure for generating airflow through the enclosure to dissipate heat. The fan may be turned on when a temperature detected by the temperature sensor reaches a pre-determined threshold.

### FIELD OF THE INVENTION

The present application relates to a heating apparatus and in particular to a heating apparatus for mounting within a ceiling.

Embodiments of the present invention provide a heating apparatus adapted for mounting within a ceiling having temperature control means. However, it will be appreciated that the invention may be applicable in broader contexts and other applications.

### BACKGROUND

Typically, heating systems within the home are either situated on the ground, on wall installations or on the ceiling. With the latter, it is desirable to have the heating system installed at least partially within the ceiling cavity for aesthetic and other reasons. However, this can provide issues related to safety of heat distribution, as the build-up of heat within the ceiling cavity could be a fire hazard.

Any discussion of the background art throughout the specification should in no way be considered as an admission that such art is widely known or forms part of common general knowledge in the field.

### SUMMARY OF THE INVENTION

In accordance with one aspect of the present invention, there is provided a heating apparatus for mounting within a ceiling, the heating apparatus including:
an enclosure;
a heating element mounted to a portion on the enclosure;
a temperature sensor for detecting a temperature of the enclosure;
a fan located within the enclosure for generating airflow through the enclosure to dissipate heat;
wherein the fan is turned on when a temperature detected by the temperature sensor reaches a pre-determined threshold.

Typically, the heating apparatus may be configured for mounting within a ceiling such that a lower face of the heating element is generally flush with the ceiling. The heating element may be fixedly mounted to the enclosure and remains in place during operation.

Advantageously, the heating apparatus can be mounted within the ceiling to provide minimalistic appearance by creating a simple and uncluttered ceiling space. The heating apparatus provides effective heat dissipation away from the heating element by operation of the temperature sensor and fan. It has been found that, the heat dissipation provided by the heating apparatus is sufficient such that movement of the heating apparatus outside a ceiling cavity during operation is not required.

The heating element may be mounted in any suitable location with respect to the enclosure. In some embodiments, the heating element may be mounted to a base portion of the enclosure.

In some embodiments, the enclosure is configured for mounting in a space between adjacent ceiling joists of the ceiling.

In some embodiments, the enclosure may include an inlet and an outlet for allowing airflow through the enclosure, the inlet and the outlet each being located proximate opposite ends of the enclosure. In particular, the inlet and outlet may be defined in a base portion of the enclosure such that communication of airflow can be established between the enclosure and a heated space below the ceiling. In other embodiments, the inlet and outlet may be located at any suitable location. In some embodiments, the enclosure may include a single outlet for directing airflow out of the enclosure. For example, the airflow from the ceiling cavity may be directed into the enclosure via gaps between walls of the enclosure, and an airflow may be directed out of the enclosure into a space below the ceiling via the outlet. In this case, the fan may be positioned above the heating element for directing airflow from the ceiling cavity into the enclosure and out via the outlet. The outlet may be located at either end of the enclosure or under the heating element on a base portion of the enclosure.

In some embodiments, the temperature sensor is located distal to the fan within the enclosure.

In some embodiments, the enclosure has an elongate body having an inlet end and an outlet end, the inlet being defined at the inlet end of the body and outlet being defined at the outlet end of the body, wherein the fan is mounted within the enclosure proximate the inlet end, and the temperature sensor is mounted externally to the body of the enclosure proximate the outlet end, and wherein the heating element is mounted to the base portion of the enclosure between the fan and the temperature sensor.

In some embodiments, the enclosure has an angled portion proximate the outlet.

In some embodiments, the temperature sensor is mounted to the angled portion of the enclosure externally to the enclosure.

In some embodiments, the temperature sensor is provided by a thermal switch. The thermal switch may be operatively configured to turn on the fan when the temperature sensed by thermal switch reaches a pre-determined upper threshold.

In some embodiments, the thermal switch is operatively configured to turn off the fan when the temperature sensed by the thermal switch reaches a pre-determined lower threshold.

In some embodiments, the fan remains operational after the heating element is turned off until the temperature sensed by the temperature sensor reaches the pre-determined lower threshold.

In some embodiments, the thermal switch is an automatic thermal reset switch.

In some embodiments, the heating element is adapted to turn off when a temperature of the enclosure reaches a maximum pre-determined threshold.

In some embodiments, the heating apparatus further includes a fail-safe switch, the fail-safe switch being operatively configured to turn off the heating element when a temperature detected by the fail-safe switch reaches the maximum pre-determined threshold.

In some embodiments, the heating apparatus further includes a power supply, and the fail-safe switch is operatively configured to turn off the heating element by means of a supply disconnect relay for disengaging the heating element from the power supply when a temperature detected by the fail-safe switch reaches the maximum pre-determined threshold.

In some embodiments, the power supply and the heating element are connected in parallel. In particular, the heating element may be connected in parallel to the fan and temperature sensor. Advantageously, the heating apparatus may include a heating module and a temperature control module. The heating module may include the heating element and fail-safe switch for turning off the heating element when a maximum pre-determined temperature threshold is reached. The temperature control module may include the fan and thermal switch for operating the fan as previous discussed. Each of the heating module and the temperature control module may be connected in parallel to the power supply such that operation of the temperature control module is not affected by any operating errors associated with the heating module, and vice versa.

In some embodiments, the power supply, fail-safe switch and supply disconnect relay are mounted in a terminal box externally to the enclosure. Advantageously, electrical components housed in the terminal box externally to the enclosure can be protected from high temperatures of the enclosure.

In some embodiments, the fail-safe switch is a manual thermal reset switch.

In some embodiments, the fan is mounted within the enclosure proximate one end of the enclosure such that the terminal box is located adjacent to an inlet side of the fan.

In some embodiments, the fan is mounted within the enclosure proximate one end of the enclosure such that the terminal box is located adjacent an inlet side of the fan. Advantageously, operation of the fan typically cools the end of the enclosure proximate the terminal box more rapidly than the rest of the enclosure. This facilitates cooling the terminal box to prevent overheating of the electrical components therein.

### BRIEF DESCRIPTION OF THE FIGURES

Example embodiments of the disclosure will now be described, by way of example only, with reference to the accompanying drawings in which:

FIG. 1 is a perspective view of a heating apparatus in accordance with an embodiment of the invention;

FIG. 2 is an exploded view of the heating apparatus shown in FIG. 1;

FIG. 3 is a side view of the heating apparatus shown in FIG. 1;

FIG. 4 is a perspective view of the heating apparatus installed within a ceiling cavity in accordance with an embodiment of the invention;

FIG. 5 is a schematic diagram of a circuit associated with the heating apparatus shown in FIG. 1; and

FIG. 6 is a flow diagram exemplifying the operation of the circuit of FIG. 5.

### DETAILED DESCRIPTION

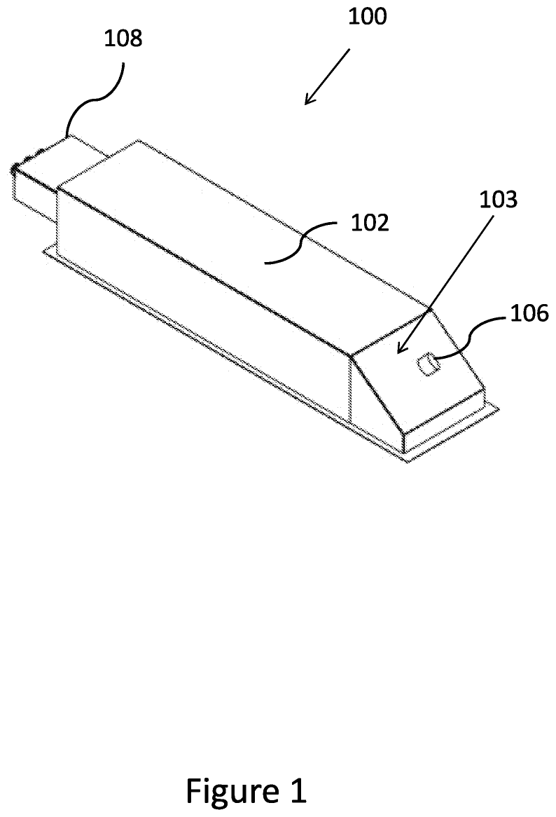

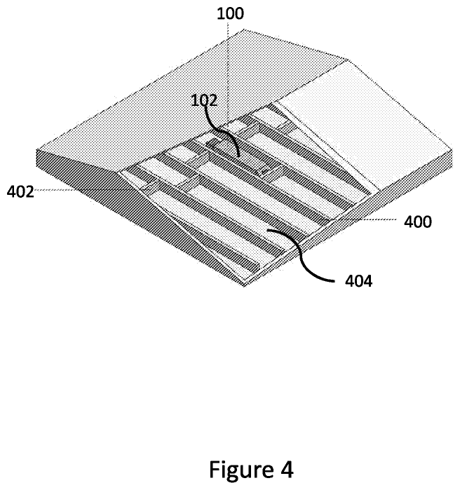

FIG. 1 shows a perspective view of an enclosure 102 of a heating apparatus 100 for mounting within a ceiling in accordance with an embodiment of the invention. The enclosure 102 may be fabricated from a variety of materials including galvanized steel, aluminium, or stainless steel as a few examples. Preferably, the materials from which the enclosure is fabricated are resistant to corrosion and fire given its intended location within a ceiling. The heating apparatus 100 is configured for fitment between ceiling joists 400 within a ceiling cavity 402 as is exemplified in FIG. 4 and as such, in the embodiment shown, the enclosure 102 has an elongate body. The enclosure 102 may take a variety of different shapes within the confines of a typical roofing installation, with rectangular or elongate proportions being preferable for fitment in the space between adjacent ceiling joists 400 within a ceiling.

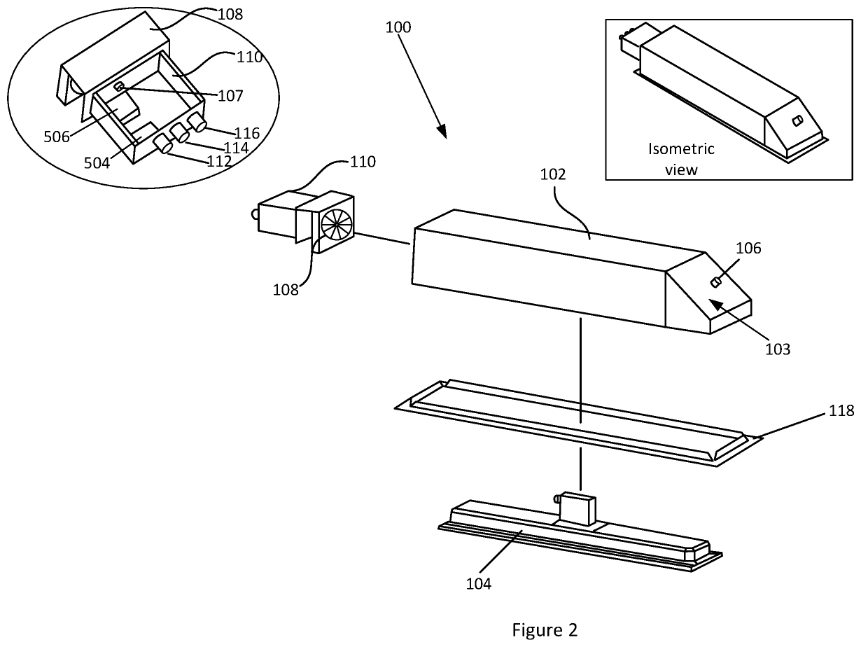

Referring to FIG. 2, an exploded view of the heating apparatus 100 is shown. The heating apparatus 100 includes an enclosure 102 with a heating element 104 mounted to the base portion of the enclosure 102. The heating apparatus 100 further includes a temperature sensor 106 which is located externally to the enclosure 102. In some embodiments, the enclosure 102 may define an aperture. A temperature sensing element of the temperature sensor 106 may be aligned with the aperture, received by the aperture or passed through the aperture such that the sensing element is in communication with the airflow within the enclosure 102 to thereby enable the temperature sensor 106 to more readily detect a temperature inside the enclosure 102. In the embodiment shown, the temperature sensor 106 is connected to a terminal box 110 via an electrical connection 105. The electrical connection is situated externally to the enclosure 102. In this arrangement, the risk of overheating the electrical connection 105 during operation of the heating element 104 is reduced as the electrical connection 105 is provided externally to the enclosure 102.

The heating apparatus 100 includes a fan 108 which is adapted to turn on when a temperature within the enclosure 102, and as detected by the temperature sensor 106, reaches a pre-determined upper threshold. The fan 108 is mounted at one end of the enclosure 102 proximate the terminal box 110. As more clearly illustrated in FIG. 2, the fan 108 is attached to the terminal box 110 and can be mounted within the enclosure 102 as a single unit during assembly. The terminal box 110 is mounted externally to the enclosure 102.

As more clearly shown in FIG. 2, the terminal box 110 houses electrical components including a fail-safe switch 107 provided by a manual thermal switch, a supply disconnect relay 506 and transformer 504. The fail-safe switch 107 is operatively configured to turn off the heating element 104 by means of the relay 506 for disengaging the heating element 104 from the power supply 502 when a temperature detected by the fail-safe switch 107 reaches the maximum pre-determined threshold. The transformer 504 steps down the power from the mains power supply. The terminal box 110 further provides terminals 112, 114, 116 for connection to the AC power input, connecting the power input to a user control panel 109 and connecting the power output to the heating element 104 respectively.

In practice, the heating apparatus 100 is adapted for installation and operation within a roof cavity 402 as more clearly exemplified in FIG. 4. As can be seen in FIG. 4, the heating apparatus 100 is configured for mounting between ceiling joists 400 within the ceiling cavity 402. The heating apparatus 100 may be fixed to the ceiling joists 400 by way of a variety of fastening means, such as screws, nails or bolts (not shown) which may pass through the ceiling joists 400 providing a secure means of attaching the heating apparatus 100 to the ceiling joists 400.

In one embodiment, the enclosure 102 is mounted between the ceiling joists 400 such that a bottom face 118 of the enclosure 102 is flush with the ceiling panels 404. In this embodiment, an aperture may be provided in the ceiling panels 404 to allow the bottom face 118 of the enclosure 102 to be received therein such that the bottom face 118 is exposed to the space below the ceiling panels 404. In another embodiment, enclosure 102 may be entirely hidden behind the ceiling panels 404. In this embodiment, the bottom face 118 may be located proximate the ceiling panels 404 so that heat from the apparatus 100 radiates through the ceiling panels into the space below the ceiling.

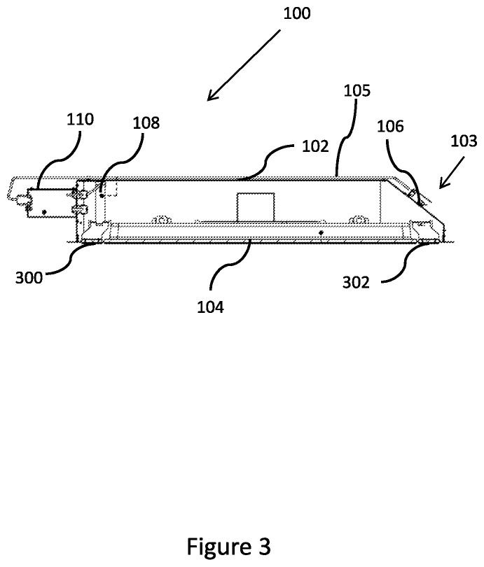

Referring to FIG. 3, the heating apparatus 100 may include an inlet 300 and an outlet 302. The inlet 300 and the outlet 302 are located at either end of the heating element 104. The inlet and outlet (300, 302) provide a means for airflow throughout the heating apparatus 100 to aid in temperature regulation within the heating apparatus 100. The location of the inlet 300 and the outlet 302 at opposite ends of the heating element 104 allows for airflow in a longitudinal direction along the length of the heating element 104. The airflow in the longitudinal direction in relation to the heating element 104 provides convectional heat transfer through the flow of air in the vicinity of the heating element 104.

Moreover, the location of the inlet 300 and outlet 302 generally in line with a lower face 118 of the heating element 104 enables excess heat from the enclosure 102 to be redirected from the ceiling cavity downwards into the space below the ceiling, thereby providing more effective heating for the space below the ceiling.

With particular reference to FIGS. 1 to 3, the temperature sensor 106 is located distal from the fan 108. The location of the temperature sensor 106 distal from the fan 108 reduces the likelihood of rapid fluctuation of the temperature within the vicinity of the temperature sensor 106 which may undesirably result in more frequent switching of the fan 108 from its on/off state. It also prevents switching off the fan 108 prematurely as the temperature gradient may vary within the enclosure such that temperatures proximate the fan 108 are typically lower than temperatures elsewhere in the enclosure 102.

As can be seen in FIGS. 1 to 3, in the embodiment shown, the enclosure 102 has an angled portion 103 which is in the vicinity of the outlet 302. In particular, the angled portion is located on one end of the enclosure 102 opposite the terminal box 110. The temperature sensor 106 can be mounted on the angled portion 103 externally to the enclosure 102 without increasing the overall height of the enclosure 102. For example, if the temperature sensor 106 were located on the top of the enclosure 102, this would add to the height of the enclosure 102, which in many cases may be limited within a roof cavity. By locating the temperature sensor 106 on the angled portion 103 of the enclosure 102, the height of the enclosure 102 is not affected by the location of the temperature sensor 106. As is best exemplified in the embodiment shown in FIG. 3, the angled portion 103 is located near the outlet 302, providing the added benefit of more effectively funnelling the airflow downwards towards the outlet 302.

It will be appreciated that the height within a ceiling cavity 402 may be limited and any reductions in the height of the heating apparatus 100 may be critical to the installation of the heating apparatus 100 within the ceiling cavity 402. In some embodiments, the temperature sensor 106 is provided by a thermal switch which is operatively configured to turn on the fan 108 when the temperature reaches a predetermined upper threshold. Similarly, the thermal switch is operatively configured to turn off when the sensed temperature reaches a lower pre-determined threshold.

The thermal switch may take a number of forms including a bimetallic device whereby a bimetallic strip is used to open and close the switch based on temperature fluctuations. Alternatively, electronic temperature thermal switches may be used to provide greater accuracy in the calibration of switching temperature. Preferably, the thermal switch is an automatic thermal reset switch whereby the thermal switch is automatically self-resets (i.e. disconnects the fan 108 from the power supply) when the sensed temperature reduces below a lower threshold.

As an added safety feature, the heating apparatus 100 also include fail-safe switch 107 which is adapted to turn off the heating element 104 when a maximum pre-determined temperature threshold is reached within the enclosure 102. This fail-safe switch 107 is intended to act as an override in the case that other switching mechanisms fail within the heating apparatus 100. For example, if the fan 108 becomes faulty and the temperature of the enclosure 102 exceeds a maximum temperature threshold, the fail-safe switch 107 can be triggered to switch off the heating element 104 via the supply disconnect relay 506.

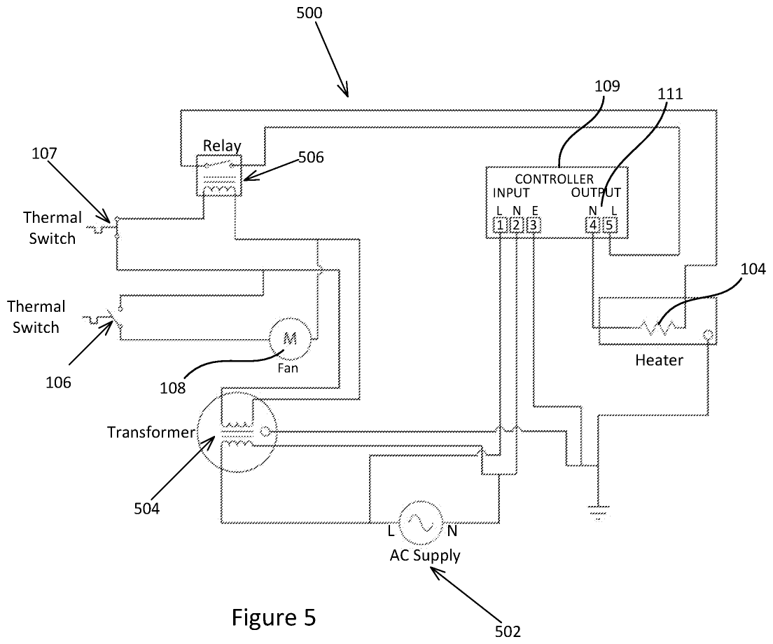

Now referring to FIG. 5, a circuit schematic 500 illustrating the circuit configuration of the heating apparatus 100 is shown.

As can be seen in FIG. 5, the circuit 500 is comprised of two main circuits operating in parallel. The two main circuits comprise a low voltage circuit for operating the fan 108 (temperature control module) and a high voltage circuit for providing controllable power output 111 to the heating element 104 via user control panel 109 (heating module). Both circuits are provided with power from an AC mains power supply 502. The output voltage of the power supply 502 is transformed down to an appropriate operating voltage via a step-down transformer 504.

In the heating module 602, stepped-down power via the transformer 504 is coupled in parallel across the fail-safe switch 107 (thermal switch) and relay 506. During normal operation, the fail-safe switch 107 is closed and the coil in the relay 506 is energised such that the relay 506 is also closed, and power is provided to the heating element 104. When a temperature detected by the fail-safe switch 107 exceeds a maximum threshold (e.g. 80° C.), the fail-safe switch 107 opens, de-energising the relay 506 thereby causing the relay 506 to open and disconnect the heating element 104 from the power supply 502. The relay 506 can be used for switching the high current circuit associated with the heating element 104. The user control panel 109 also allows a user to switch the heating element 104 on/off and adjust the amount of current supplied to the heating element 104 to adjust the temperature of the heating element 104 via a user interface (not shown). In particular, the user control panel 109 can be used to control the output 111 to the heating element 104 whereby the current feeding the heating element 104 is adjustable by the user. The user interface may include buttons and/or a wireless communication module for receiving wireless control signals from a remote controller (not shown).

The fail-safe switch 107 may include a manual thermal reset (MTR) switch which can be calibrated to disconnect the heating element 104 once the heating element 104 has reached an upper threshold temperature. The MTR switch may be located within the enclosure at a variety of locations for sensing the interior temperature of the enclosure 102. In the embodiment shown, the MTR is located in the terminal box 110.

In other embodiments, the relay 506 may be circumvented by using a fail-safe switch 107 with a current rating which is sufficiently high to reliably switch the current provided to the heating element 104.

In the temperature control module604, stepped-down power via the transformer 504 is coupled in parallel across the temperature senor 106 and fan 108. The temperature sensor 106 is provided by a thermal switch which controls the on/off operation of the fan 108 based on calibrated upper and lower temperature thresholds. In one embodiment, the thermal switch 106 is configured to turn on the fan 108 when a detected temperature reaches an upper threshold (e.g. 60° C.), and turn off the fan 108 when a detected temperature reaches a lower threshold (e.g. 45° C.). In some embodiments, the temperature sensor 106 may take a variety of forms including resistance temperature detectors (RTDs), thermocouples or thermistors as some examples.

As shown in FIG. 5, the heating module and the temperature control module are each connected in parallel to the power supply 502 to enable independent operation. In this manner, the fail-safe switch 107 can operate to disconnect the heating element 104 in the event that the fan 108 and/or temperature sensor 106 fails. Similarly, the fan 108 can continue to operate even after the heating element 104 is turned off, for example if the temperature within the enclosure 102 remains above the lower temperature threshold of the sensor 106 due to thermal inertia.

In an alternative arrangement, the heating apparatus 100 may be operatively configured to adjust the speed of the fan 108 within prescribed ranges based on the temperature sensed by the temperature sensor 106. As a failsafe means of operation, the heating apparatus 100 may be adapted to monitor the fan 108 and if the fan 108 fails, power to the heating element 104 is cut, avoiding the circumstance of the heating element 104 operating without the thermal control of the fan 108.

In some embodiments, the transformer 504 may be omitted from the circuit configuration 500 and electrical components compatible with mains power (e.g. 240V) can be used.

As discussed, the heating apparatus 100 is operatively configured to keep the fan 108 operating for a predetermined period of time after the heating element 104 has been turned off. This provides the benefit of reducing the effects of thermal inertia, whereby the heat within the enclosure 102 can exceed specified upper heat ranges for electrical components and cabling within the enclosure 102 if the fan 108 and heating element 104 are turned off at the same time. By continuing to operate the fan 108 after the heating element 104 has been turned off, this provides additional cooling via airflow along the heating element 104 to reduce the chance of thermal inertia increasing the temperature within the enclosure 102 to undesirable levels.

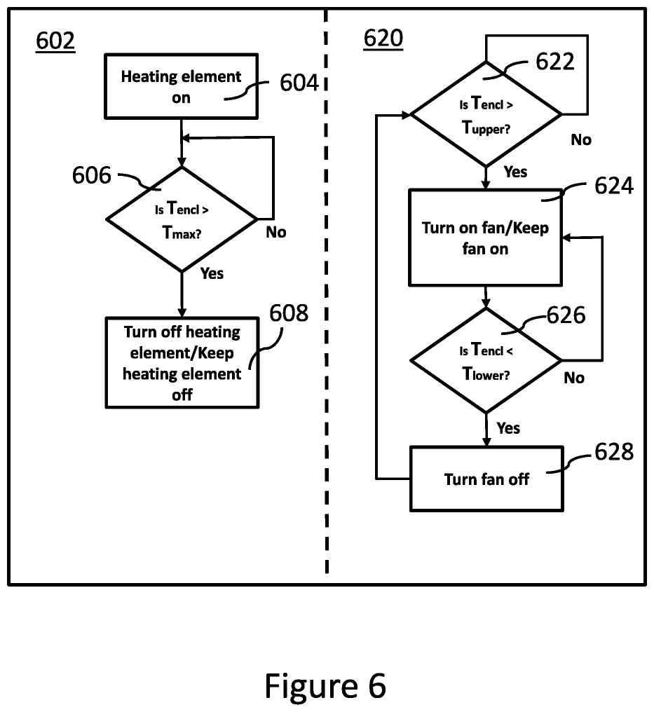

FIG. 6 is a flow chart illustrating the independent operations of the heating module 602 and temperature control module 604 discussed above with reference to FIG. 5. In the heating module 602, the fail-safe switch 107 is calibrated to control the heating element 104 by monitoring the temperature within the enclosure (T_{encl}) and if the temperature exceeds a maximum temperature of 80° C. (Tₘₐₓ) the fail-safe switch 107 is adapted to open the relay 506 thereby cutting power to the heating element 104. Typically, the fail-safe switch 107 is a manual reset switch. For safety reasons, it would be desirable for a technician to inspect the heating apparatus 100 in the event that the fail-safe switch 107 is triggered by reaching the maximum temperature threshold. For example, the heating apparatus 100 may be installed incorrectly. In these embodiments, the fail-safe switch 107 will require manual resetting after it has been triggered, for example, after inspection or servicing by a technician. In an alternative embodiment, the fail-safe switch 107 may be an automatic thermal switch. As the temperature inside the enclosure falls below a threshold where T_{encl}<Tₘₐₓ, the fail-safe switch 107 may automatically close, re-energising the relay 506 and providing power to the heating element 104.

At step 604, a user switches on the heating element 104 via user control panel 109.

At query step 606, if the temperature within or proximate the enclosure (T_{encl}) exceeds a maximum temperature threshold (Tₘₐₓ), the fail-safe switch 107 will open and the method proceeds to step 608. If not, the method returns to step 606, the fail-safe switch 107 remains closed and no changes are made to the operation of the heating module 602.

At step 608, the fail-safe switch 107 is open, and the heating element 104 is switched off via the supply disconnect relay 506.

At query step 610, the fail-safe switch 107 may be either automatically or manually reset if the temperature within or proximate the enclosure (T_{encl}) reduces below the maximum temperature threshold (Tₘₐₓ). If not, the fail-safe switch 107 remains open and the heating element 104 remains disconnected from the power supply 502.

In the temperature control module 620, the fan 108 is controlled via the thermal switch 106, where the temperature of the enclosure (T_{encl}) is compared to an upper temperature threshold (Tᵤₚₚₑᵣ) which in the embodiment shown may be set at 60° C.

When the temperature within the enclosure (T_{encl}) reaches the upper temperature threshold (Tᵤₚₚₑᵣ), the thermal switch 106 closes and turns on the fan 108 providing cooling within the enclosure 102 and thus reducing the temperature within the enclosure 102. When the temperature within the enclosure (T_{encl}) reaches a lower threshold (T_{lower}) (e.g. 45 C.), the fan 108 is turned off, otherwise the fan 108 is kept on until the temperature falls below the lower temperature threshold (T_{lower}) in which case the fan 108 is turned off.

At query step 622, the thermal switch 106 is closed if the temperature within the enclosure (T_{encl}) exceeds the upper temperature threshold (Tᵤₚₚₑᵣ), and the fan 108 is turned on and the method proceeds to step 624. If not, the thermal switch 106 remains open and the fan 108 is off.

At step 624, the fan 108 is on to dissipate heat within the enclosure 102.

At query step 626, the thermal switch 106 automatically resets if the temperature within the enclosure (T_{encl}) reduces below the lower temperature threshold (T_{lower}), and the fan is turned off at step 628. If not, the thermal switch 106 remains closed and the fan 108 continues operation and the method returns to step 624. After step 628, the method returns to query step 622.

### INTERPRETATION

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

1. A heating apparatus for mounting within a ceiling, the heating apparatus including:
an enclosure;
a heating element mounted to a portion on the enclosure;
a temperature sensor for detecting a temperature of the enclosure;
a fan located within the enclosure for generating airflow through the enclosure to dissipate heat;
wherein the fan is turned on when a temperature detected by the temperature sensor reaches a pre-determined threshold.

2. The heating apparatus of claim 1, wherein the enclosure is configured for mounting in a space between adjacent ceiling joists of the ceiling.

3. The heating apparatus of claim 1, wherein the enclosure further includes an inlet and an outlet for allowing airflow through the enclosure, the inlet and the outlet each being located proximate opposite ends of the enclosure.

4. The heating apparatus according to claim 1, wherein the temperature sensor is located distal to the fan within the enclosure.

5. The heating apparatus according to claim 3, wherein the enclosure has an elongate body having an inlet end and an outlet end, the inlet being defined at the inlet end of the body and outlet being defined at the outlet end of the body, wherein the fan is mounted within the enclosure proximate the inlet end, and the temperature sensor is mounted externally to the body of the enclosure proximate the outlet end, and wherein the heating element is mounted to a base portion of the enclosure between the fan and the temperature sensor.

6. The heating apparatus of claim 3, wherein the enclosure has an angled portion proximate the outlet.

7. The heating apparatus of claim 6, wherein the temperature sensor is mounted to the angled portion of the enclosure externally to the enclosure.

8. The heating apparatus of preceding claim 1, wherein the temperature sensor is provided by a thermal switch, the thermal switch being operatively configured to turn on the fan when the temperature sensed by thermal switch reaches a pre-determined upper threshold.

9. The heating apparatus of claim 8, wherein the thermal switch is operatively configured to turn off the fan when the temperature sensed by the thermal switch reaches a pre-determined lower threshold.

10. The heating apparatus according to claim 1, wherein the fan remains operational after the heating element is turned off until the temperature sensed by the temperature sensor reaches the pre-determined lower threshold.

11. The heating apparatus of claim 8, wherein the thermal switch is an automatic thermal reset switch.

12. The heating apparatus of according to claim 1, wherein the heating element is adapted to turn off when a temperature of the enclosure reaches a maximum pre-determined threshold.

13. The heating apparatus of claim 9, wherein the heating apparatus further includes a fail-safe switch, the fail-safe switch being operatively configured to turn off the heating element when a temperature detected by the fail-safe switch reaches the maximum pre-determined threshold.

14. The heating apparatus of claim 11, wherein the heating apparatus further includes a power supply, and the fail-safe switch is operatively configured to turn off the heater by means of a supply disconnect relay for disengaging the heating element from the power supply when a temperature detected by the fail-safe switch reaches the maximum pre-determined threshold.

15. The heating apparatus of claim 14, wherein the power supply and the heating element are connected in parallel.

16. The heating apparatus of claim 14, wherein the power supply, fail-safe switch and supply disconnect relay are mounted in a terminal box externally to the enclosure.

17. The heating apparatus of claim 14, wherein the fail-safe switch is a manual thermal reset switch.

18. The heating apparatus of claim 16, wherein the fan is mounted within the enclosure proximate one end of the enclosure such that the terminal box is located adjacent an inlet side of the fan.

19. The heating apparatus according to claim 1, wherein the apparatus configured for mounting within a ceiling such that a lower face of the heating element is generally flush with the ceiling.

20. The heating apparatus according to claim 1, wherein the heating element is fixedly mounted to the enclosure and remains in place during operation.
